(19) United States
(12) Patent Application Publication
(10) Pub. No.: US 2016/0366144 A1
(43) Pub. Date: Dec. 15, 2016

(54) System Security Using Multi-user Control

(71) Applicant: Huawei Technologies Co., Ltd., Shenzhen (CN)

(72) Inventors: Peter Ashwood-Smith, Gatineau (CA); Tao Wan, Ottawa (CA)

(21) Appl. No.: 14/735,902

(22) Filed: Jun. 10, 2015

(51) Int. Cl. H04L 29/06; G06F 21/62

(52) U.S. Cl. CPC H04L 63/102; G06F 21/6218

(57) ABSTRACT

An authorization method comprising receiving command signals from a plurality of controlling accounts, determining whether the number of received command signals meets a threshold, wherein the threshold is at least two, and executing a controlled function in response to the determination. An authorization method comprising accessing a control interface as a first controlling account for a controlled function, communicating command instructions for sending a command with a second controlling account for the controlled function, and sending the command in accordance with the command instructions, wherein sending the command satisfies an authorization condition for executing the controlled function.

### BACKGROUND

In a system, a super-user mode or system administrator mode for a device may allow a user to perform privileged operations such as system rebooting and system modifications. In a super-user mode, a device, a system, or a network may be susceptible to operator errors, and malicious activities, which may cause damage to the system or the network. For example, an operator may be misled by an attacker to reboot a system into a mode that leaves the system vulnerable to attack. Enabling an operator to securely authorize privileged operations and other system operations may be desirable for protecting a system and a network from operator errors and malicious activities.

### SUMMARY

In one embodiment, the disclosure includes an authorization method comprising receiving command signals from a plurality of controlling accounts, determining whether the number of received command signals meets a threshold, wherein the threshold is at least two, and executing a controlled function in response to the determination.

In another embodiment, the disclosure includes an authorization method comprising accessing a control interface as a first controlling account for a controlled function, communicating command instructions for sending a command with a second controlling account for the controlled function, and sending the command in accordance with the command instructions, wherein sending the command satisfies an authorization condition for executing the controlled function.

In yet another embodiment, the disclosure includes an apparatus comprising a receiver, a memory, and a processor coupled to the memory and the receiver, and configured to access a control interface as a first controlling account from a set of controlling accounts, communicate command instructions for sending a command with a second controlling account from the set of controlling accounts, signal the command in accordance with the command instructions, receive a second command from the second controlling account in accordance with the command instructions, and execute a controlled function in response to receiving the second command.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a system.

FIG. 2 is a schematic diagram of an embodiment of a network element.

FIG. 3 is a schematic diagram of an embodiment of multi-user control protocol.

FIG. 4 is a schematic diagram of an embodiment of a system implementing multi-user control.

FIG. 5 is a schematic diagram of another embodiment of a system implementing multi-user control.

FIG. 6 is a schematic diagram of an embodiment of a multi-user control method.

### DETAILED DESCRIPTION

It should be understood at the outset that, although an illustrative implementation of one or more embodiments are provided below, the disclosed systems and/or methods may be implemented using any number of techniques, whether currently known or later developed. The disclosure should in no way be limited to the illustrative implementations, drawings, and techniques illustrated below, including the designs and implementations illustrated and described herein, but may be modified within the scope of the appended claims along with their full scope of equivalent.

Disclosed herein are various embodiments for allowing an operator to implement multi-user control for performing system operations, privileged operations, and network operations. The security of a system, a network, a device, a network device, an operating system (OS), a hypervisor, or an application may be enhanced by using multi-user control and may reduce risks associated with performing critical system operations. Multi-user control increases system security by using a plurality of controlling accounts to satisfy one or more authorization conditions to execute system operations. Using multiple controlling accounts increases accountability when executing system operations. The authorization conditions add an additional layer of security by requiring specific commands and actions to be performed before executing system operations. In an embodiment, a plurality of controlling accounts for a control interface is established. The control interface is configured with one or more authorization conditions for authorizing a system operation for execution. When a plurality of controlling accounts access the control interface and signal commands, the control interface determines whether the authorization conditions have been satisfied and executes the system operation when the authorization conditions have been satisfied. A controlled function is a system operation or a privileged operation that is executed using the control interface and using multi-user control.

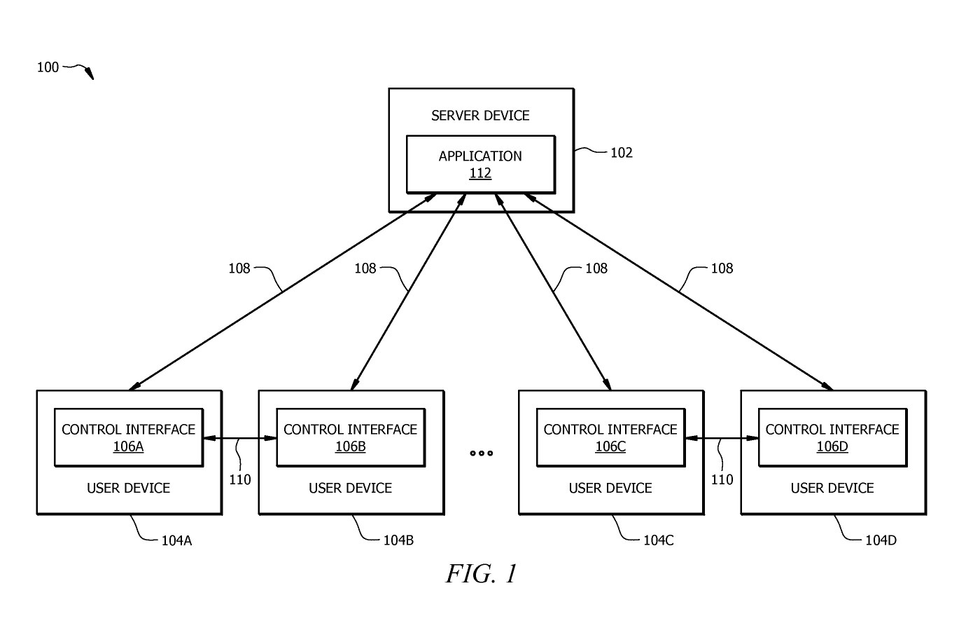

FIG. 1 is a schematic diagram of an embodiment of a system 100 where an embodiment of the present disclosure may operate. System 100 includes a server device 102 and user devices 104A-104D. Server device 102 is a network node configured to support the transportation of data traffic through a network. For example, server device 102 may include a switch, a router, or any other suitable networking device for communicating data packets or supporting the transportation of data packets as would be appreciated by one of ordinary skill in the art upon viewing this disclosure, or combinations thereof. Server device 102 is coupled to user devices 104A-104D using connections 108. Examples of connections 108 include, but are not limited to, links, tunnels, an internet connection, wireless network connections, and wired network connections. Links discussed herein may be physical links, such as electrical links, optical links, and/or logical links (e.g., virtual links). A tunnel may include, but is not limited to, an Internet Protocol (IP) security (IPsec) tunnel or a generic routing encapsulation (GRE) tunnel. In an embodiment, server device 102 has an application 112 configured to execute controlled functions using multi-user control. In an alternative embodiment, application 112 is stored in at least one of user device 104A-104D. Application 112 may include one or more applications, an operating system (OS), for example, Windows or Linux, and a hypervisor, for example Kernel-based Virtual Machine (KVM) or VMware. For example, server device 102 may be configured as a virtual machine or to implement a virtual machine. A virtual machine may be implemented using any suitable protocol and/or implementation as would be appreciated by one of ordinary skill in the art upon viewing this disclosure. Application 112 is configured to interact with or to be accessed by control interfaces 106A-106D to execute system operations and privileged operations as controlled functions using two or more of the control interfaces 106A-106D when authorization conditions have been satisfied. Application 112 is configured to receive commands for the controlled function from the control interfaces 106A-106D to execute one or more controlled functions. Application 112 is configured to establish a set of controlling accounts for a control interface, to configure one or more authorization conditions for controlled functions that are implemented by the control interface, to detect or determine when controlling accounts are accessing the control interface, to receive command signals for a controlled function, to determine whether the authorization conditions have been satisfied, and to execute the controlled function when the authorization conditions have been satisfied.

Control interfaces 106A-106D can be realized as a virtual element, a physical network element, or embedded in a physical element. Control interfaces 106A-106D may be stored in or accessed by user devices 104A-104D, respectively. In an embodiment, control interfaces 106A-106D may use a graphical user interface (GUI) and may be instances of a common control interface for the application 112 which may be accessible by each of the user devices 104A-104D. In an alternative embodiment, control interfaces 106A-106D may use a hardware interface that uses one or more user inputs. User devices 104A-104D are configured to communicate data and commands with application 112 stored in server device 102 using control interfaces 106A-106D. User devices 104A-104D may include notebook computers, tablet computers, desktop computers, mobile telephones, servers, or any other suitable networking devices as would be appreciated by one of ordinary skill in the art upon viewing this disclosure, or combination thereof. User devices 104A-104D may be located in about the same geographical location or different geographical locations. User devices 104A-104D may have or access one or more applications, an OS, and/or a hypervisor. Control interfaces 106A-106D may be configured to communicate commands for a controlled function to the one or more applications, the OS, and/or the hypervisor. In an embodiment, operators for user devices 104A-104D communicate with each other using in-band communication 110. In-band communication 110 includes, but is not limited to, communications using application 112 and control interfaces 106A-106D. Control interfaces 106A-106D may be configured to communicate commands for a controlled function, command instructions, and/or feedback with each other. For example, control interface 106A may be configured to receive feedback when control interface 106B signals a command for a controlled function. In another embodiment, user devices 104A-104D may be configured to communicate with each other using out-of-band communication. For example, operators using user devices 104A-104D may communicate or provide feedback with each other using telephone, email, instant messenger, text messaging, Internet, any other out-of-band communication technique as would be appreciated by one of ordinary skill in the art upon viewing this disclosure, or combinations thereof.

While the embodiment of FIG. 1 is disclosed with respect to a particular configuration of server device 102 and user devices 104A-104D, it is noted that the system 100 may include any suitable number of server devices 102 and/or user devices 104A-104D and/or configuration of server devices 102 and/or user devices 104A-104D as would be appreciated by one of ordinary skill in the art upon viewing this disclosure.

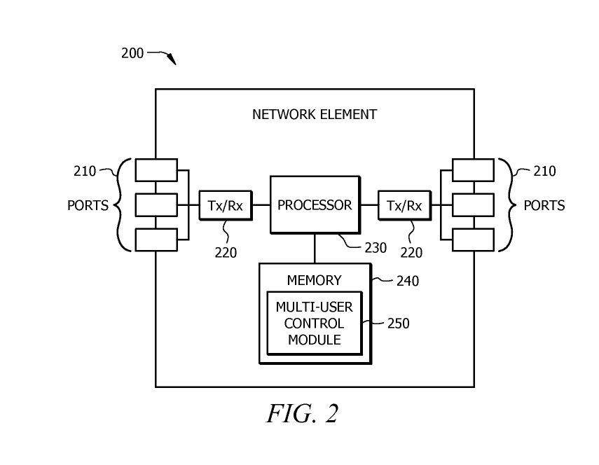

FIG. 2 is a schematic diagram of an embodiment of a network element 200. The network element 200 may be suitable for implementing the disclosed embodiments. Network element 200 may be any device (e.g., a modem, a switch, router, bridge, server, client, controller, etc.) that transports or assists with transporting data through a network, system, and/or domain. For example, network element 200 may be in and/or integrated within a server device 102 or a user device 104A-104D in FIG. 1. Network element 200 includes ports 210, transceiver units (Tx/Rx) 320, a processor 230, and a memory 240 comprising a multi-user control module 250. Ports 210 are coupled to Tx/Rx 220, which may be transmitters, receivers, or combinations thereof. The Tx/Rx 220 may transmit and receive data via the ports 210. Processor 230 is configured to process data. Memory 240 is configured to store data and instructions for implementing embodiments described herein. The network element 200 may also include electrical-to-optical (EO) components and optical-to-electrical (OE) components coupled to the ports 210 and Tx/Rx 220 for receiving and transmitting electrical signals and optical signals.

The processor 230 may be implemented by hardware and software. The processor 230 may be implemented as one or more central processing unit (CPU) chips, logic units, cores (e.g., as a multi-core processor), field-programmable gate arrays (FPGAs), application specific integrated circuits (ASICs), and digital signal processors (DSPs). The processor 230 is in communication with the ports 210, Tx/Rx 220, and memory 240.

The memory 240 includes one or more of disks, tape drives, and solid-state drives and may be used as an over-flow data storage device, to store programs when such programs are selected for execution, and to store instructions and data that are read during program execution. The memory 240 may be volatile and non-volatile and may be read-only memory (ROM), random-access memory (RAM), ternary content-addressable memory (TCAM), and static random-access memory (SRAM). Multi-user control module 250 is implemented by processor 230 to execute the instructions for implementing various embodiments for establishing a set of controlling accounts for a control interface, configuring one or more authorization conditions for the control interface, detecting or determining when a plurality of controlling accounts are accessing the control interface, receiving a plurality of command signals for a controlled function, determining whether the authorization conditions have been satisfied, and executing the controlled function or system operation when the authorization conditions have been satisfied. The inclusion of multi-user control module 250 provides an improvement to the functionality of network element 200. The multi-user control module 250 also effects a transformation of network element 200 to a different state. Alternatively, multi-user control module 250 is implemented as instructions stored in the processor 230.

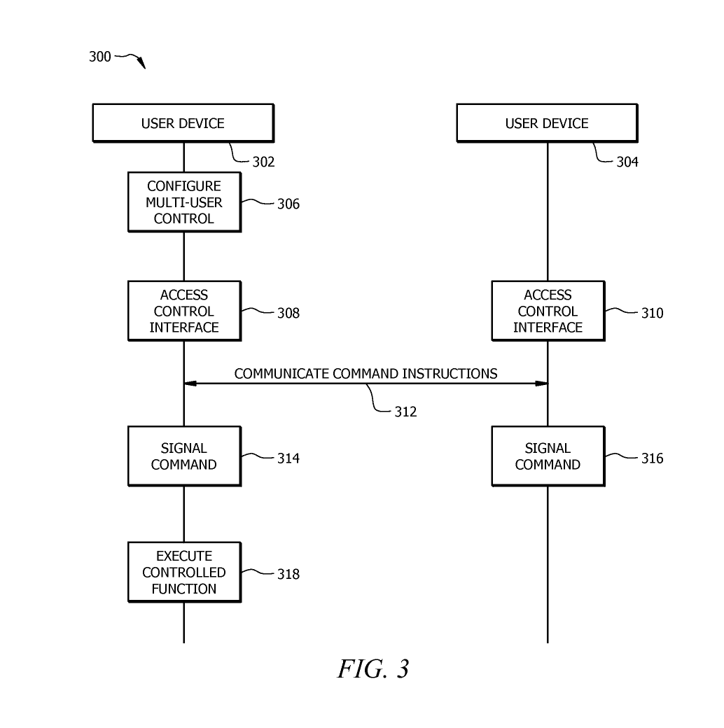

FIG. 3 is a schematic diagram of an embodiment of multi-user control protocol 300. User devices 302 and 304 may be configured similarly to user devices 104A-104D in FIG. 1. User devices 302 and 304 are configured to access a control interface for an application, to communicate command instructions for a controlled function, to signal one or more commands, and to execute the controlled function for the application. In FIG. 3, the application may be stored in or accessed by user device 302. At step 306, user device 302 is configured for implementing multi-user control to execute one or more controlled functions for an application using a control interface. For example, user device 302 is configured in a mode that allows the operator to create one or more controlling accounts. Controlling accounts may be established for operators or devices that are authorized to access a control interface to execute system operations using multi-user control. Access may be limited or restricted to the controlling account by using one or more user authentication protocols such as a log-in or password. A controlling account may be associated with one or more controlling account identifiers to differentiate the controlling account from other controlling accounts. Examples of a controlling account identifier include, but are not limited to, a geographical location identifier, a machine identifier (e.g., a media access control (MAC) address), a network identifier (e.g., an IP address), and a mnemonic identifier (e.g., a controlling account name). Controlling accounts may be established for user devices 302 and 304. User device 302 may also be configured with one or more mandatory or optional authorization conditions. User device 302 is configured to execute one or more controlled functions for the application when the authorization conditions are satisfied by the control interfaces. Authorization conditions may include, but are not limited to, the number of controlling accounts accessing the control interface, a minimum number of controlling accounts accessing the control interface, authorized geographical locations for accessing the control interface, authorized network addresses for accessing the control interface, the number of controlling accounts in the number of authorized locations accessing the control interface, a timeout threshold, a minimum/maximum time interval between commands for an issued command, the number of similar or the same commands. For example, user device 302 may be configured, such that, the authorization conditions are satisfied when two controlling accounts access the control interface from two different authorized locations and when the two controlling accounts signal the same command. It is noted that the same command may not be case-sensitive and may be literally different, but directed at the same common command to be executed. For instance, a command may be written in lowercase for a user device and the same command may be written in uppercase for another user device. Additionally, user device 302 and the control interface may be configurable between an active mode that enables multi-user control and an inactive mode that disables multi-user control.

At step 308, when a controlled function is to be executed, user device 302 accesses the control interface. At step 310, user device 304 also accesses the control interface. User device 304 may access the control interface before user device 302 accesses the control interface, after user device 302 accesses the control interface, or simultaneously when user device 302 accesses the control interface. At step 312, user device 302 and user device 304 communicate command instructions with each other. The command instructions include instructions sending or signaling one or more commands for a controlled function or one or more authorization conditions to be signaled by the control interfaces of the user devices 302 and 304 to execute the controlled function. User device 302 and 304 may use out-of-band communication to communicate commands and command instructions. For example, an operator for user device 302 and an operator for user device 304 may communicate commands and command instructions via telephone. User device 302 and 304 may also use in-band communication to communicate commands and command instructions. For example, an operator for user device 302 and an operator for user device 304 may communicate commands and command instructions via their respective control interface. At step 314, user device 302 signals the commands for the controlled function indicated by the command instructions using the control interface. At step 316, user device 304 also signals the commands for the controlled function indicated by the command instructions using the control interface. For example, a command for a controlled function by an OS can be to reboot the OS into a maintenance mode. In another example, a command for a controlled function by a hypervisor can be to create a virtual machine (VM) or a bridge. User device 304 may signal the commands before user device 302 signals the commands using the control interface, after user device 302 signals the commands using the control interface, or simultaneously when user device 302 signals the commands using the control interface. At step 318, when the authorization conditions have been satisfied, user device 302 uses the control interface to execute the controlled function for the application. In an embodiment, user device 302 and/or user device 304 may receive a notification or a confirmation when a command has been signaled by other user devices that are accessing a control interface or when a controlled function is executed.

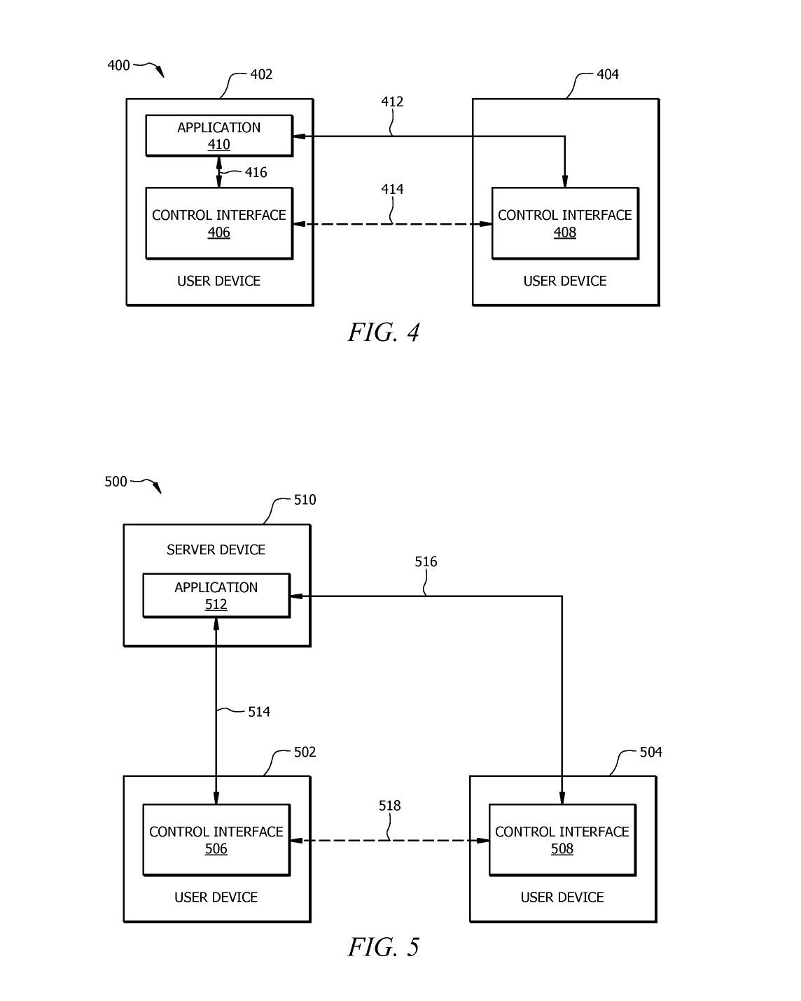

FIG. 4 is a schematic diagram of an embodiment of a system 400 implementing multi-user control using a multi-user protocol, for example, multi-user protocol 300 in FIG. 3. System 400 includes user device 402 and user device 404. User devices 402 and 404 may be in the same geographical location or in different geographical locations and may be configured similarly to user devices 104A-104D in FIG. 1. User device 402 has a control interface 406 configured to interact (shown as arrowed line 416) with an application 410 and to execute one or more controlled functions for application 410 using multi-user control. Application 410 is configured to execute a controlled function for application 410 when authorization conditions have been satisfied for the controlled function by at least two control interfaces, for example, control interfaces 406 and 408. User device 404 has a control interface 408 configured to interact (shown as arrowed line 412) with application 410 to execute one or more controlled functions for application 410. In an embodiment, control interface 408 is configured to communicate with control interface 406 using in-band communication 414. Multi-user control can be configured using control interfaces 406 and 408 similarly to step 306 in FIG. 3. For example, control interface 406 and control interface 408 are configured to establish controlling accounts for user devices 402 and 404 and to establish one or more authorization conditions for implementing a controlled function for application 410. In order to execute a controlled function for application 410, an operator for user device 402 may access control interface 406 and an operator for user device 404 may access control interface 408. The operator for user devices 402 and the operator for user device 404 communicate command instructions for executing the controlled function with each other using out-of-band communication and/or in-band communication 414, when available. Control interfaces 406 and 408 are configured to signal one or more commands to application 410 in accordance with the command instructions. For example, control interfaces 406 and 408 may be configured to communicate the same command to execute a controlled function. When application 410 determines that the authorization conditions have been satisfied, user device 402 and application 410 execute the controlled function.

FIG. 5 is a schematic diagram of another embodiment of a system 500 implementing multi-user control using a multi-user protocol, for example, multi-user control protocol 300 in FIG. 3. System 500 includes server device 510, user device 502, and user device 504. Server device 510, user device 502, and user device 504 may be in the same geographical location or in different geographical locations and may be configured similarly to server device 102 and user devices 104A-104D in FIG. 1, respectively. Server device 510 may include an application 512 and may be configured to execute one or more controlled functions for application 512 using multi-user control. Application 512 is configured to execute a controlled function when authorization conditions have been satisfied for the controlled function by at least two control interfaces, for example, control interfaces 506 and 508. User device 502 has a control interface 506 configured to interact (shown as arrowed line 514) with an application 512 to execute one or more controlled functions for application 512 using multi-user control. User device 504 has a control interface 508 configured to interact (shown as arrowed line 516) with application 512 to execute one or more controlled functions for application 512 using multi-user control. In an embodiment, control interface 508 is also configured to communicate with control interface 506 using in-band communication 518. Multi-user control can be configured using control interfaces 506 and 508 similarly to step 306 described in FIG. 3. For example, control interface 506 and control interface 508 are configured to establish controlling accounts for user devices 502 and 504 and to establish one or more authorization conditions for a controlled function for application 512. In order to execute a controlled function for application 512, an operator for user device 502 may access control interface 506 and an operator for user device 504 may access control interface 506. The operator for user devices 502 and the operator for user device 504 communicate command instructions for executing the controlled function with each other using out-of-band communication and/or in-band communication 518, when available. Control interfaces 506 and 508 are configured to signal one or more commands to application 512 in accordance with the command instructions. For example, control interfaces 506 and 508 may be configured to communicate the same command to execute a controlled function. When application 512 determines the authorization conditions have been satisfied, server device 510 and application 512 execute the controlled function.

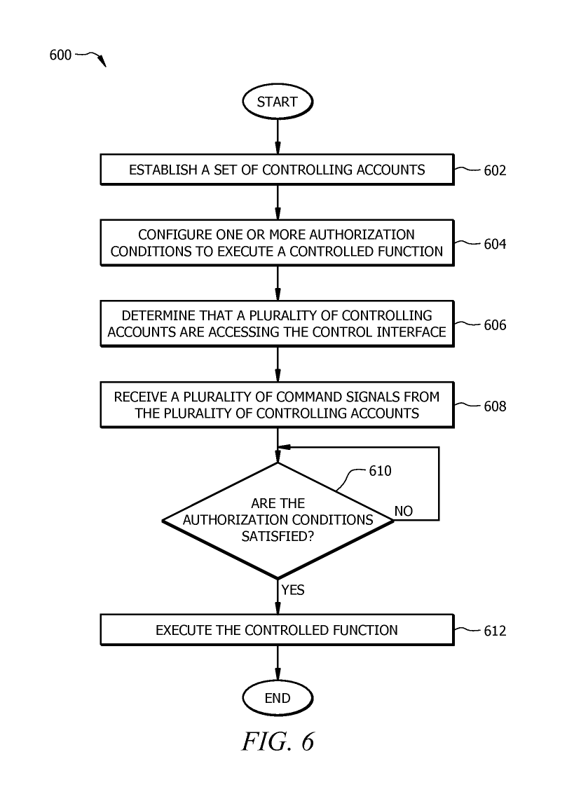

FIG. 6 is a schematic diagram of an embodiment of a multi-user control method 600 for a network device such as user device 104A-104D or server device 102 in FIG. 1. In an embodiment, method 600 is implemented for an application in a network to establish a set of controlling accounts for a control interface, to configure one or more authorization conditions for the control interface to execute a controlled function for an application, to detect or determine when a plurality of controlling accounts are accessing the control interface, to receive a plurality of command signals for a controlled function, to determine whether the authorization conditions have been satisfied, and to execute the controlled function for the application when the authorization conditions have been satisfied. The network device establishes a set of controlling accounts for an application using a control interface for the application. Controlling accounts may be obtained or established for users that are authorized to execute controlled functions for the application using multi-user control. The application may establish the set of controlling accounts similarly to step 306 in FIG. 3.

At step 602, the network device configures one or more mandatory and/or optional authorization conditions to execute a controlled function for the application. Additionally, the network device may configure the control interface into an active mode that enables multi-user control. Configuring one or more authorization conditions may be performed similarly to step 306 described in FIG. 3. At step 604, the network device determines that a plurality of controlling accounts from the set of controlling accounts is accessing the control interface for the application. For example, the network device may identify one or more controlling accounts that are accessing the control interface using controlling account identifiers. At step 606, the network device receives command signals for the application from the plurality of controlling accounts that are accessing the control interface. At step 608, the network device determines whether the authorized conditions have been satisfied to execute the controlled function. When the authorized conditions have been satisfied, the network device may proceed to step 610; otherwise, the network device may remain at step 608. At step 610, the network device executes the controlled function for the application.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed:

1. An authorization method comprising:
receiving command signals from a plurality of controlling accounts;
determining whether the number of received command signals meets a threshold, wherein the threshold is at least two; and
executing a controlled function in response to the determination.

2. The method of claim 1, wherein each of the command signals is the same command.

3. The method of claim 1, wherein the threshold is at least three.

4. The method of claim 1, further comprising determining whether one or more authorization conditions for the controlled function are satisfied in response to receiving the command signals.

5. The method of claim 4, wherein the authorization conditions indicate a number of command signals from the plurality of controlling accounts to satisfy the authorization conditions.

6. The method of claim 4, wherein the authorization condition indicates a number of authorized locations for the plurality of controlling accounts to satisfy the authorization conditions.

7. The method of claim 4, wherein the authorization conditions indicates a timeout threshold for receiving the command signals from the plurality of controlling accounts.

8. An authorization method comprising:
accessing a control interface as a first controlling account for a controlled function;
communicating command instructions for sending a command with a second controlling account for the controlled function; and
sending the command in accordance with the command instructions, wherein sending the command satisfies an authorization condition for executing the controlled function.

9. The method of claim 8, wherein communicating command instructions with the second controlling account uses in-band communication.

10. The method of claim 8, wherein communicating command instructions with the second controlling account uses out-of-band communication.

11. The method of claim 8, wherein a number of controlling accounts to satisfy the authorization condition is two.

12. The method of claim 8, wherein the authorization condition indicates a number of authorized locations to satisfy the authorization conditions.

13. The method of claim 8, wherein the authorization condition indicates a timeout threshold for sending the command.

14. An apparatus comprising:
a receiver;
a memory; and
a processor coupled to the memory and the receiver, and configured to:
access a control interface as a first controlling account from a set of controlling accounts;
communicate command instructions for sending a command with a second controlling account from the set of controlling accounts;
signal the command in accordance with the command instructions;
receive a second command from the second controlling account in accordance with the command instructions; and
execute a controlled function in response to receiving the second command.

15. The apparatus of claim 14, wherein the processor is configured to determine whether authorization conditions that are associated with the controlled function are satisfied.

16. The apparatus of claim 15, wherein the authorization conditions indicate a number of command signals from the controlling accounts accessing the control interface to satisfy the authorization conditions.

17. The apparatus of claim 15, wherein the authorization conditions indicate a minimum number of command signals from the controlling accounts accessing the control interface to satisfy the authorization conditions.

18. The apparatus of claim 15, wherein the authorization condition indicate a number of authorized locations to satisfy the authorization conditions.

19. The apparatus of claim 14, wherein the first command and the second command are the same.

20. The apparatus of claim 14, wherein communicating command instructions with the second controlling account from the set of controlling accounts comprises using in-band communication, out-of-band communication, or both.
